(19) United States
(12) Patent Application Publication
(10) Pub. No.: US 2005/0017833 A1
(43) Pub. Date: Jan. 27, 2005

(54) Timing apparatus

(76) Inventor: Robert C. Rajewski, Stettler (CA)

Correspondence Address: THOMPSON LAMBERT;SUITE 703D, CRYSTAL PARK TWO, 2121 CRYSTAL DRIVE, ARLINGTON, VA, 22202, US

(21) Appl. No.: 10/662,311

(22) Filed: Sep. 16, 2003

(30) Foreign Application Priority Data
Jul. 21, 2003 (CA) 2,435,639

(51) Int. Cl. H01H 9/00

(52) U.S. Cl. 335/205

(57) ABSTRACT

A timing apparatus is comprised of a magnet attached to the second hand of a clock and a reed switch. As the magnet passes by the reed switch, the reed switch closes and completes the circuit. The timing apparatus is used to control a pilotless ignition system that ignites waste gases in flare stacks from electrical discharges. The timing apparatus is also used to control a pipeline injection system.

### BACKGROUND OF THE INVENTION

Timing is required to regulate a sequence of events, or to ensure the periodic occurrence of an event. Timing can be provided in many different ways. Street lights are switched twice a day, when the level of light collected drops below a certain level, and when it rises above a certain level. The timing of this switching is therefore variable with the season and the amount of daylight. In IC circuits, a common timing technique is to use the time constant of a RC circuit, as can be seen in a multivibrator. In digital systems, an external clock pulse combined with logic gates can move a circuit through a number of states to provide control.

An example of where timing is used is in the petroleum industry. In producing petroleum products, waste gas is often accumulated and must be disposed of. Current safety regulations require that waste gas be burned or flared before being released into the atmosphere to prevent any explosion hazards or fire. This is commonly done through the use of a flare stack, with the gas being burned as it is vented out the top of the flare stack. A common method of igniting the gas is to use electrodes to generate a spark. To conserve energy, the electrodes need only generate a spark periodically, which requires a timing apparatus. Another example in the petroleum industry is injecting fluids into a pipeline, for example, methanol as a hydrate inhibitor in a natural gas pipeline. Often, a membrane and plunger setup is used, and the switching is provided by the position of the plunger. Another new method is to use a combination of differential motor valves that open and close in a sequence as an injector, which requires a different timing strategy. In both examples, what is required is a reliable timing apparatus that can work remotely, and is easy to replace or repair. This disclosure presents a novel way of giving reliable timing in an inexpensive manner.

### SUMMARY OF THE INVENTION

In a preferred embodiment of the invention, there is provided a timing apparatus to provide switching, the apparatus comprising: a clock with a sweeping hand, and a switch positioned to be operated by movement of the sweeping hand of the clock. The switch may be operated by a magnet carried by the sweeping hand; in which case, the switch is a magnetically operated switch, the switch positioned to be activated by sweeping the magnet past the magnetically operated switch. The sweeping hand may be a sweeping second hand. The magnetically operated switch may close in a sufficient magnetic field. The magnetically operated switch may be a reed switch. The second hand may be counterbalanced by a mass opposite the magnet. The clock may be positioned such that the mechanical hand moves in a horizontal plane. A plurality of hands may be mounted on the clock and move with the sweeping hand, each the plurality of hands carrying a magnet such that the frequency of switching is increased. A plurality of mechanical switches may be controlled by the magnet attached to the second hand. The magnetically operated switch may be incorporated in an electric circuit.

In another preferred embodiment, the electric circuit is an ignition system for a flare stack.

In another preferred embodiment, the electric circuit is a control mechanism for a fluid injector. The fluid injector may be used to inject fluid into a pipeline transporting natural gas. The fluid injector may inject a hydrate inhibitor.

### BRIEF DESCRIPTION OF THE DRAWINGS

There will now be given a brief description of the preferred embodiments, by way of example, and not with the intent of limiting the scope of the invention, where like reference characters refer to like elements, and in which:

FIG. 1 shows the timing apparatus according to an embodiment of the invention;

FIG. 2 shows an ignition system incorporating the timing apparatus as the timer;

FIG. 3 shows a timing apparatus with a higher switching frequency;

FIG. 4 shows a timing apparatus controlling more than one circuit, and

FIG. 5 shows an injector system incorporating the timing apparatus as the timer.

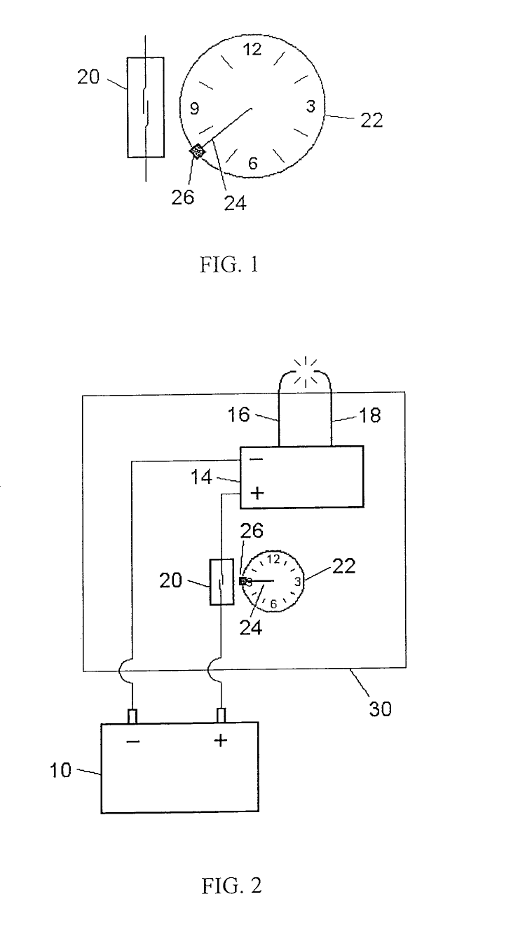

### DESCRIPTION OF THE PREFERRED EMBODIMENTS

In the following description, the use of the indefinite article “a” does not exclude the possibility that more than one element is present.

The timing apparatus according to a preferred embodiment is shown in detail in FIG. 1. The apparatus consists of a clock 22 that has a sweeping hand 24, such as a second hand, and a magnet 26 that is carried by the sweeping hand. The timing apparatus also includes a switch 20 that is responsive to a magnetic field, such as a reed switch, located adjacent to the clock. As the second hand turns, the magnet periodically passes the reed switch 20, which is normally open and will close in a magnetic field. In this arrangement, timing is provided.

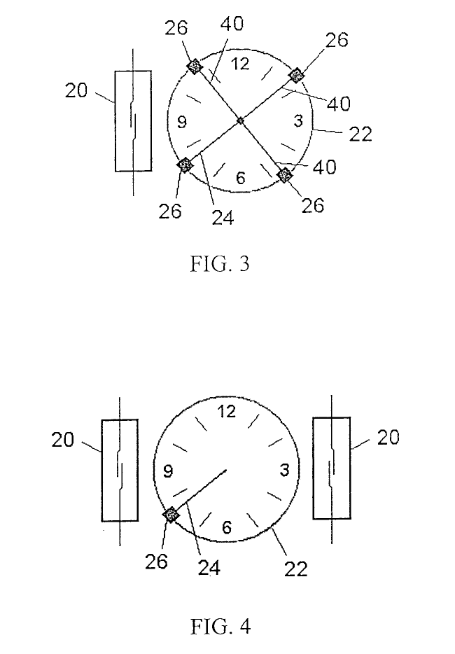

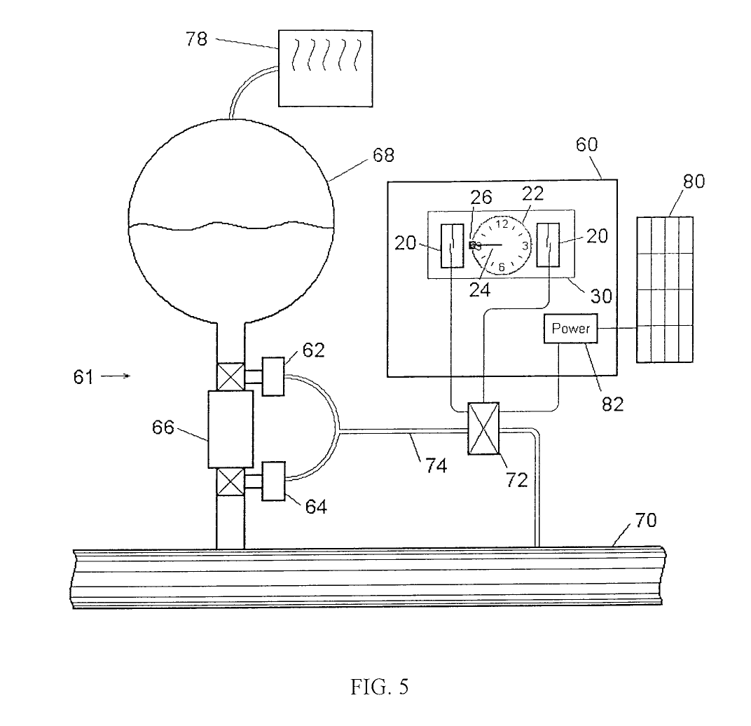

By using a clock with a magnet attached to the second hand, the user is not limited to a period of 60 seconds to repeat the cycle. Shorter periods can be obtained by attaching more hands to the moving parts of the clock. For example, FIG. 3 shows a clock 22 with three extra hands 40 moving with the second hand 24, all four hand with magnets 26 attached, such that the reed switch 20 closes every 15 seconds. In this way, periods of 30s, 20s, 15s, 12s, 10s etc are accessible, by adding the necessary number of hands and magnets. This apparatus can also control more than one circuit, as shown in FIG. 4 where another reed switch 20 is introduced adjacent to the path of the second hand 24 and magnet 26.

Attaching a magnet to the second hand also has another effect. By attaching a weight on the second hand, the user will be placing extra strain on the gears, which will cause the clock to wear out more quickly. To counteract this problem, two strategies can be employed. One is to lay the clock flat, such that the second hand moves horizontally, and never has to move the magnet against gravity. Another option is to place a counter balance opposite the magnet such that the gears of the clock are not lifting any extra weight against gravity. The problem is inherently solved which two or more magnets are used, as they provide the necessary counterbalance, although it is important to have magnets of the same weight to ensure this.

This method of switching is inexpensive and reliable, and takes no advanced skill to operate or to maintain. The clock, such as a quartz clock, can be a commercially available clock with a sweeping hand, such as a clock made by SKP of Japan. The user need only attach a magnet to the desired sweeping hand to allow it to function. Reed switches are also available, for example from Reed Switch Developments Corporation. The requirement is that the clock and reed switch be located to allow switching to occur in normal operation. The timer design also allows the user to troubleshoot the circuit easily, since it will be quite apparent whether the clock is functioning, and if the clock is not working, replacing it is neither complex nor expensive.

FIG. 4 shows the timing apparatus being incorporated into a flare ignition system. The timing apparatus 30 is connected between a power supply 10, which in this case is a battery, and a pulsing transformer 14, which may be a transformer produced by Custom Coils of South Dakota, capable of producing a short pulse of energy with the necessary voltage across the electrodes 16 and 18. A pulsing transformer 14 allows the user generated a short pulse each time a magnet 26 closes the reed switch 20, even though the switch may be closed for a longer period of time, allowing the user to conserve energy. The timing apparatus may be equipped with more than one magnet 26 to produce sparks at a higher frequency according to the invention. While the physical placement of the elements of the flare ignition system may vary according to the situation, the elements will preferably be protected from the burning gases and from weather, and will be accessible for repairs in conventional fashion.

Referring to FIG. 5, the invention is used as the timer for an injector 61 for injecting fluids into a pipeline 70, such as for injecting hydrate inhibitor into a natural gas pipeline. A source 68 of fluid to be injected, such as methanol, is situated above the first motor valve such that the displacer tube 66 fills. Preferably, the tank is an overhead storage tank. There is also shown a first and a second motor valve 62 and 64, the first motor valve 62 having a larger force constant and being connected to regulate flow between the source of fluid and a displacer tube 66, the second motor valve 64 having a lesser force constant and being connected to regulate flow between the displacer tube 66 and the pipeline 70. Connected to the first and second motor valve 62 and 64 is a control line 74 which controls the first and second motor valve 62 and 64. At the other end of the control line 74 is a control valve 72 that pressurizes and depressurizes the control line 74. The control valve 72 can be a latching solenoid valve such as a Skinner brand solenoid from the Parker Hannifin Corporation of Cleveland, Ohio. The operation of the latching solenoid valve 72 is controlled by a control panel 10.

The control panel 60 includes the timing apparatus 36 according to the present invention to control the latching solenoid valve 72, and a power source 82 to supply the valve 72 with power. The timing apparatus 30 is arranged to send alternating pulses that cause the solenoid valve 72 to open and close. The solenoid valve 72 may be powered by a battery 82 so that the injector can be used in remote locations. The battery 82, in turn, can be connected to a photovoltaic converter 80, such as those available from Siemens, that charges the battery 82, allowing for an extended life in remote locations.

When used with a natural gas pipeline, the overhead storage tank 68 will fill with pressurized natural gas. This can be then used to fuel a heater such as a Cata-Dyne™ heater built by Thermal Technologies of Edmonton, Alberta.

In a further embodiment, the switch may for example use interruption of a light path to trigger the switch. In this case, the switch may use a combination of a light emitter and a photodetector, and the magnet is not required, the switch being activated by the passage of the sweeping arm past the switch and interrupting the light path between the light emitter, such as a light emitting diode, and the photodetector.

A person skilled in the alt may make immaterial modifications to the disclosed invention without departing from the invention.

1. A timing apparatus to provide switching, the apparatus comprising:
a clock with a sweeping hand; and
a switch positioned to be activated by passage of the sweeping hand past the switch.

2. The timing apparatus of claim 1 further comprising:
a magnet carried by the sweeping hand;
the switch being a magnetically operated switch; and
the switch positioned to be activated by sweeping of the magnet past the magnetically operated switch.

3. The timing apparatus of claim 2 in which the sweeping hand is a sweeping second hand.

4. The timing apparatus of claim 2 in which the magnetically operated switch closes in a sufficient magnetic field.

5. The timing apparatus of claim 2 in which the magnetically operated switch is a reed switch.

6. The timing apparatus of claim 2 in which the second hand is counterbalanced by a mass opposite the magnet.

7. The timing apparatus of claim 2 in which the clock is positioned such that the mechanical hand moves in a horizontal plane.

8. The timing apparatus of claim 1 in which a plurality of sweeping hands are mounted on the clock and move with the sweeping hand, each of the plurality of sweeping hands being positioned in relation to the switch to operate the switch.

9. The timing apparatus of claim 2 in which a plurality of sweeping hands are mounted on the clock and move with the sweeping hand, and each the plurality of hands carrying a magnet such that the frequency of switching is increased.

10. The timing apparatus of claim 1 in which a plurality of switches are controlled by the sweeping hand.

11. The timing apparatus of claim 2 in which a plurality of switches are controlled by movement of the sweeping hand.

12. The timing apparatus of claim 1 in which the switch is incorporated in an electric circuit.

13. The timing apparatus of claim 12 in which the electric circuit is an ignition system for a flare stack.

14. The timing apparatus of claim 2 in which the switch is incorporated in an electric circuit.

15. The timing apparatus of claim 14 in which the electric circuit is an ignition system for a flare stack.

16. The timing apparatus of claim 12 in which the electric circuit is a control mechanism for a fluid injector.

17. The timing apparatus of claim 16 in which the fluid injector is used to inject fluid into a pipeline transporting natural gas.

18. The timing apparatus of claim 14 in which the electric circuit is a control mechanism for a fluid injector.

19. The timing apparatus of claim 17 in which tile fluid injector injects a hydrate inhibitor.
